(19) United States
(12) Patent Application Publication
(10) Pub. No.: US 2007/0053519 A1
(43) Pub. Date: Mar. 8, 2007

(54) WIRELESS ADAPTER FOR DATA EXCHANGE AND METHOD

(76) Inventor: Bryan W. Godwin, Round Rock, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/468,766

(22) Filed: Aug. 30, 2006

Related U.S. Application Data
(63) Continuation-in-part of application No. 11/464,127, filed on Aug. 11, 2006.
(60) Provisional application No. 60/712,615, filed on Aug. 30, 2005.

(51) Int. Cl. H04K 1/00

(52) U.S. Cl. 380/270

(57) ABSTRACT

A wireless adapter is provided with a universal plug or jack and a wireless RS232 serial interface. The wireless adapter may include a BLUETOOTH® wireless transmitter and receiver operable to communicate data using a DEX/UCS protocol. The universal plug may be satisfactory used with conventional sockets associated with a manual telephone exchange. Such sockets are often used as communication ports at fixed facilities to allow portable computers and other portable electronic equipment to gain access to computer networks associated with such facilities.

### CROSS REFERENCE TO RELATED APPLICATION

This application is a continuation-in-part of U.S. application Ser. No. 11/464,127 filed Aug. 11, 2006, incorporated by reference herein.

This application claims priority from U.S. Provisional Patent Application Ser. No. 60/712,615, filed Aug. 30, 2005, incorporated by reference herein.”

### TECHNICAL FIELD

The present disclosure is related to equipment and methods used to exchange data associated with business functions and transactions and more particularly to a wireless serial interface and method to communicate data between a computer network and handheld wireless devices.

### BACKGROUND OF THE DISCLOSURE

Uniform Communication Standard (UCS) was established during the mid-1960s to facilitate and improve data transfer within the grocery industry. The Uniform Communication Standard may be generally described as a subset of ANSI ASCX12 national standard for electronic data interchange (EDI). UCS implementation guidelines and communication standards are now used to support transactions associated with manufacturing, retailers, wholesalers, shipping companies, brokers, public warehouse, service merchandising and many other industries. Business functions such as data administration, ordering, logistics, financial and other support activities are routinely completed using UCS guidelines and standards.

UCS standards have been applied to direct store delivery (DSD) transactions. UCS transaction sets have been developed to exchange delivery information and adjustments between buyers and sellers or suppliers using electronic devices including, but not limited to, handheld computers and personal computers at the time of delivery at individual store locations or other individual facilities. The UCS/DSD applications have two parts sometimes referred to as DEX/UCS (Data Exchange) linking computers of suppliers and sellers to facilitate exchange of delivery data at specific locations and NEX/UCS (Network Exchange) linking office computers and large enterprise communication networks with each other. DEX/UCS applications are frequently used with computerized delivery and receiving systems.

Fixed facilities such as individual grocery stores, warehouses, shipping and receiving docks and individual components, also referred to herein as field assets, such as vending machines, ice machines, and other product dispensing machines often have communication ports or access points which allow transfer of data using DEX/UCS protocols. Such communication ports or access points often include one or more sockets associated with manual telephone exchanges or sockets associated with stereo phone jacks or stereo connectors. The communication ports typically provide a serial interface for RS232 cables.

Conventional one-quarter inch (¼″) three-connector jacks or plugs may be easily inserted into such communication ports or access points to establish desired communication paths. Several companies offer relatively expensive, specialized handheld computers or other electronic devices with associated connector cables including a conventional three-connector jack or plug which may be inserted into such communication ports. A typical cable length may be approximately six feet. Due to the specialized nature of such handheld computers or other electronic devices and associated cables, the equipment can be relatively expensive and may have limited flexibility to perform multiple functions.

### SUMMARY OF THE DISCLOSURE

In accordance with teachings of the present disclosure, a wireless adapter and method are provided to substantially reduce or minimize disadvantages and problems associated with communicating data between portable electronic devices and handheld computers and computer networks associated with grocery stores, shipping and receiving docks and warehouses. The wireless adapter and method may also be used to communicate with computers and computer networks associated with individual components including, but not limited to vending machines, ice machines and beverage dispensing equipment. The wireless adapter and method may further be used to communicate with mobile computer networks associated with airplanes, trains and highway trucks when they are at a fixed location. For some applications the wireless adapter may include a wireless local area network communication device and a universal communications jack operable to engage the wireless adapter with an access point or communication port associated with a computer network and/or an enterprise communication network.

Technical benefits of the present disclosure include eliminating the need to connect a handheld computer or other electronic device to an access point or communication port using an RS232 cable. The present disclosure allows the use of wireless technology and relatively standard off-the-shelf handheld wireless components without requiring the use of specially designed cables and/or specialized handheld computers coupled with such cables. Eliminating the need for a cable or mechanical interface allows communication with a wide variety of standard wireless electronic devices. A standard wireless electronic device may move seamlessly throughout a large facility without having to connect with a cable at each communication port or access point. Installing a wireless adapter in each communication port may greatly increase efficiency of product delivery and associated data transfer. Also, handheld wireless equipment does not have to be designed (ruggedized) for multiple cable connections and disconnects during each day. The use of a wireless adapter incorporating teachings of the present disclosure may allow a handheld wireless device costing approximately $400 to replace an industrial type handheld device and cable costing over $2,000. The wireless adapter may cost approximately $200 to $300.

One aspect of the present disclosure includes providing a wireless adapter and method for directly exchanging data and other information related to business transactions between buyers and sellers of products and/or services. The wireless adapter may be releasably engaged with a communication port provided at a facility such as a vending machine, loading dock, grocery store, etc. The wireless adapter may communicate information using a DEX/UCS protocol and a wireless protocol such as BLUETOOTH wireless connectivity standards.

A further aspect of the present disclosure includes allowing the use of presently available security techniques associated with BLUETOOTH wireless technology to determine when “trusted” electronic devices may communicate with each wireless adapter and associate computer network. The wireless adapter replaces cables and associated serial port connectors.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a block diagram of selected elements of a machine to machine environment including a plurality of remotely located field assets;

FIG. 2 is a block diagram of a vending machine according to the prior art;

FIG. 3 is a block diagram of selected elements of a field asset of FIG. 1 in communication with a wireless adapter;

FIG. 4 is a flow diagram of a method of transferring data stored in field asset to a transaction server using a wireless adapter as an intermediary;

FIG. 5 is a schematic drawing showing an isometric view of an embodiment of the wireless adapter of FIG. 4 and FIG. 3 including a universal three-connector jack, a power source, a wireless transceiver, a microprocessor and associated communication applications or protocols; and

FIG. 6 is a block diagram of elements of a wireless adapter.

### DETAILED DESCRIPTION OF THE DISCLOSURE

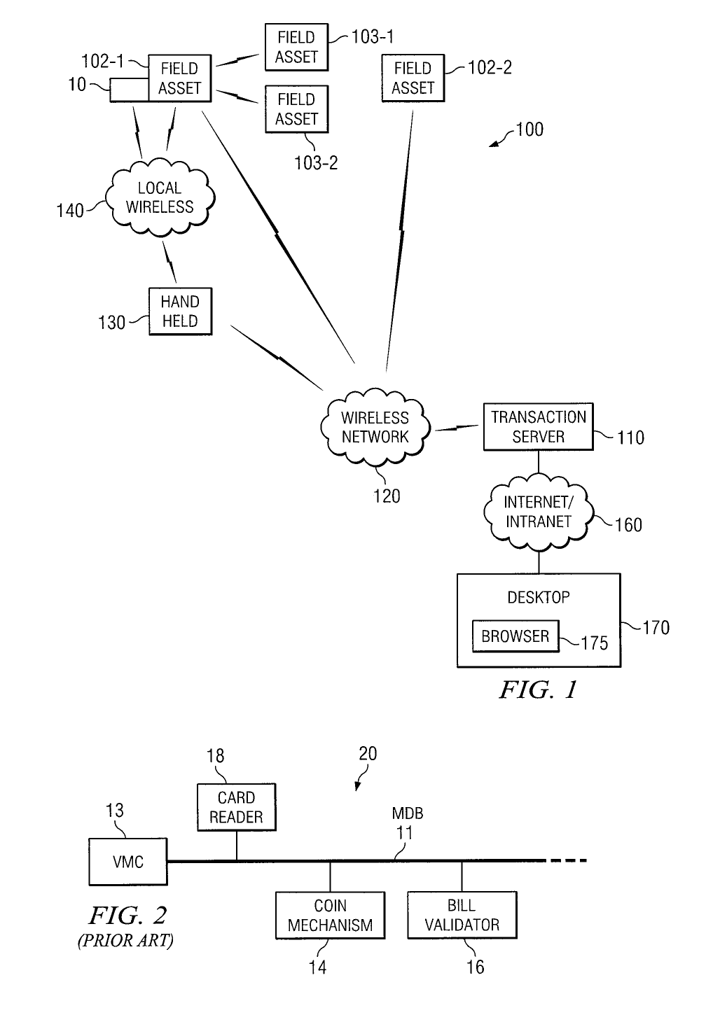

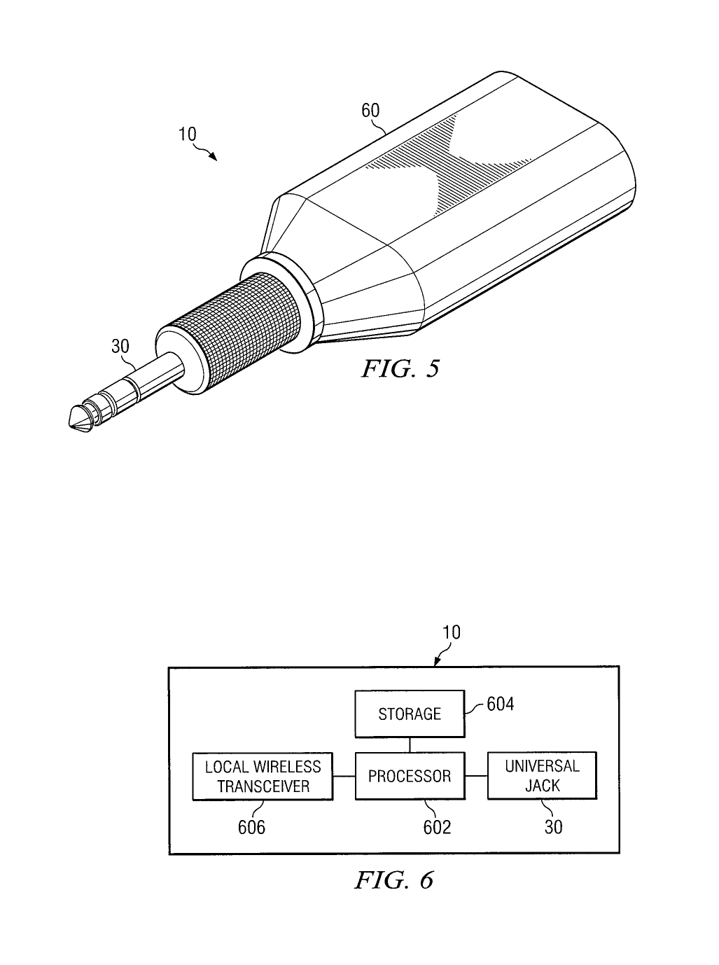

Preferred embodiments and their advantages are best understood by reference to FIG. 1 through FIG. 5, wherein like numerals indicate like and corresponding components. Where different instances of a particular element are shown, they may be numbered with hyphenated reference numerals to indicate a common design or functionality. For example, reference numerals 102-1 and 102-2 represent individual instances of a generic 102 element.

In one aspect, a machine-to-machine (M2M) network for remote field assets is described. M2M network 100 includes a collection of remotely located field assets 102, 103 in communication with a transaction processing server 110. Transaction processing server 110 communicates with a field assets 102 via a wide area wireless network or via local wireless networks using a hand held data processing device as an intermediary. Some field assets, including field assets 103, may lack wireless WAN connectivity and may, therefore, communicate with transaction processing server 110 through an intermediate field asset such as field asset 102-1. In some embodiments, field assets 102-1 may lack built-in resources for local wireless communication. In such embodiments, field asset 102-1 may communicated with hand held device 130 through the use of wireless adapter 10, which is shown in FIG. 1 as connected to field asset 102-1. Wireless adapter 10 is discussed in greater detail below.

Field assets 102 and 103 are exemplified by vending machines in which transactions likely include the sale of consumer goods stocked in the vending machine. In some embodiments, field asset 102 or 103 is an MDB compliant vending machine that includes a vending machine controller (VMC) as the master of an industry standard MDB bus to which one or more peripheral devices are connected. In addition to conventional peripheral devices such as bill validators and coin mechanisms, a field asset may include hardware, firmware, and/or software that implements a platform for providing value added functionality to the vending machine or other field asset. This collection of hardware, software, and/or firmware is referred to herein as an extended function adapter (EFA).

The EFA supports one or more beneficial capabilities that facilitate automated vending machine management. The EFA may, for example, include a audit agent that includes the capacity to perform DEX polling and to store and time stamp the captured DEX data structures.

Referring now to the drawings, FIG. 1 is a block diagram of selected elements of one embodiment of an M2M network 100 including one or more field assets, examples of which are depicted as field assets 102-1 and 102-2 (generically or collectively referred to herein as field asset(s) 102) and field assets 103-1 and 103-2. Field assets 102 are depicted in FIG. 1 as being operable to communicate with a transaction server 110. Field assets 102 may be any set of machines or devices, typically having similar functionality, that are remotely distributed and capable of engaging in some form of transaction. Examples of field assets include oil rigs, cellular phone system base stations, ATM machines, and weather monitors.

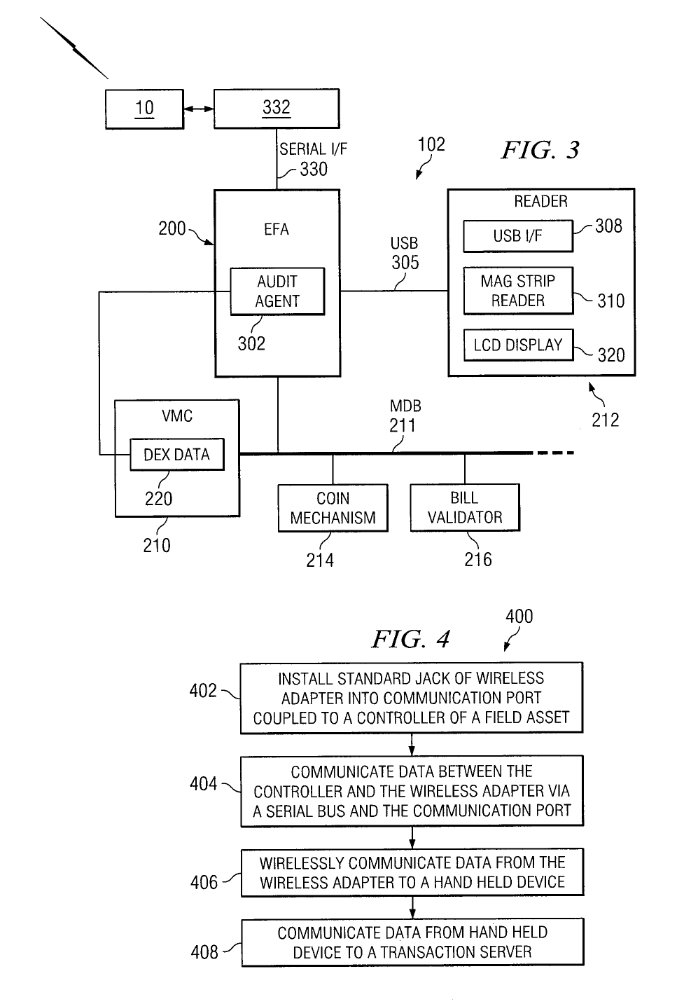

Although many different types of field assets exist, embodiments are described herein in the context of a vending machine class of field assets. Vending machines are ubiquitous machines historically used as an unmanned source of perishable and nonperishable consumer products including canned and bottled drink products, snack foods, and so forth. Details of one embodiment of a field asset are described below with respect to FIG. 3.

In the embodiment depicted in FIG. 1, field assets 102 and 103 may communicate with transaction server 110 wirelessly via alternative communication paths. Field asset 102-2 is depicted as connecting “directly” to transaction server 110 via a wireless medium and wireless network 120. Wireless network 120 may employ wireless cellular technology including the well known use of multiple base stations positioned in specified locations to communicate wireless signals across a wide geographic area.

Field asset 102-1 is depicted as being capable of communicating wirelessly with a hand held device 130 via a local wireless network 140 or directly with transaction processing server 110 via wireless net 120. As depicted in FIG. 2, field asset 102-1 may connect to hand held 130 directly or through a wireless adapter 10 connected to field asset 102-1. Field assets 103 as depicted in FIG. 2 communicate locally with field asset 102-1 and use field asset 102-1 to act as a relay station for information from devices 103-1 and 103-2.

The hand held device 130 is shown as connecting to transaction server 110 using wireless network 120, sometimes referred to herein as global wireless network to distinguish local wireless network 140. Local wireless network 140 may be implemented using any of a variety of short range wireless technologies including as perhaps the most prominent examples, Bluetooth and WiFi (e.g., IEEE 802.11b, IEEE 802.11g, and their derivatives).

In the case of local wireless communication, an operator conveys hand held device 130 to a location that is in close proximity to a field asset 102. The field asset 102 and hand held 130 establish a local wireless signal enabling communication between the two. Establishing the local wireless signal may require the use of wireless adapter 10 if field asset 102-1 does not have internal or built-in local wireless functionality. After establishing a local wireless communication channel, field asset 102 and hand held 130 exchange data or information. Field asset 102 may, as an example, transmit sales transaction information to hand held 130.

In embodiments where field asset 102 does not include built in local wireless capabilities, data may be transmitted to hand held 130 using wireless adapter 10 as an intermediary data handler, e.g., a device that receives data from field asset 102-1 over a wired connection and transmits the data to hand held 130 over a wireless connection. Hand held 130 then conveys the information it has received from field asset 102 to transaction server 110 via wireless network 120.

Alternatively, transfer of information from field asset 102-1 to transaction server 110 could be achieved by transferring the data from field asset 102-1 to hand held 130 using local wireless network 140 either with or without the use of wireless adapter 10 as an intermediary, transporting hand held 130 to a location in proximity to transaction server 110, and transmitting the information in hand held 130 to interaction server 110 via another local wireless (not depicted) transfer. In still another alternative, information may be passed from field asset 102-1 to hand held 130 and/or from hand held 130 to transaction server 110 using a cable or other wired connection, possibly to enhance the security of confidential information.

Transaction server 110 may be implemented as a set of one or more server class computers operable to process many transactions. Transaction server 110 may include, as an example, a database management application (e.g., Oracle, DB2, etc.)

A desktop data processing system 170 is depicted in FIG. 1 as being coupled to transaction server 110 via the Internet or intranet represented by reference numeral 160. Desktop 170 includes a processor, memory, and I/O peripherals according to any of various well known desktop designs. Desktop 170 includes an operating system (OS) and a conventional web browsing application represented by reference numeral 175.

As depicted in FIG. 1, M2M network 100 includes various components that facilitate high volume transaction processing in a remotely distributed architecture that includes wireless communication elements, which may be characterized by relatively unreliable or unstable communication paths to all or some of the remote assets. The elements of M2M network 100 include (1) remote communication facilities to communicate with remote assets over multiple forms of wireless networks, (2) hand held technology suitable for mobile access to the field assets and to a transaction server, (3) server software for processing volumes of transactions, and (4) browser based access to useful information provided by transaction server 110. Although not depicted explicitly in FIG. 1, value added facilities in field assets 102 and 103 include an expandable, PC industry standard communication interface to legacy equipment. The EFA serves this last function and is described in greater detail below. In the preferred embodiment, the EFA provides a platform for interfacing to archaic or otherwise unique protocols such as Data Exchange (DEX) and Multi-Drop Bus (MDB) commonly encountered in remote field asset applications and especially in the vending machine industry.

The type of information conveyed or otherwise exchanged between field assets 102 and interaction server 110 varies depending upon the manner in which and the purpose for which field asset 102 is implemented, but the information most likely includes information about transactions that occur or have occurred using field assets 102. The transaction information referred to can include, as examples, information about when a transaction occurs and other transaction details, for example, what product or combination of products were purchased, what consumer or customer purchased the product (if known), the dollar amount of the purchase, the amount of time required to complete the purchase, the manner of payment, and other information that may be useful to vending machine operators and/or the providers of goods sold through field assets 102.

Referring now to FIG. 2, selected elements of a conventional MDB-compliant vending machine 20 according to well known prior art is shown. Vending machine 20 includes a vending machine controller 13 and various peripherals devices all connected to a multi drop bus 11. The peripheral devices consist of a coin mechanism 14, a bill validator 16, and a card reader 18. As depicted in FIG. 2, MDB provides a standardized interface for connecting vending machine peripheral devices to a VMC. Although the provision of an interface to which various manufacturers of vending machine peripheral equipment can all comply is highly beneficial, the embodiment of vending machine 20 depicted in FIG. 2 does little in terms of altering the data collection and analysis paradigm of pre-existing DEX machines and does not encompass wireless communication of stored data from the vending machine to a transaction server or other networked resource. Because peripheral devices 14, 16, and 18 are essentially “dumb” devices, all of the available data resides in VMC 13 in the form of traditional DEX data structures.

Referring now to FIG. 3, an embodiment of a field asset 102 is shown. While the elements of FIG. 3 are applicable to field assets 103 of FIG. 1, the remainder of the discussion will use reference numeral 102 exclusively for the sake of simplicity. In the depicted embodiment, field asset 102 is an MDB compliant machine or device that includes a VMC 210 connected to an MDB 211, to which a plurality of peripheral devices are connected.

As shown in FIG. 2, field asset 102 has at least three peripheral devices including a coin mechanism 214, a bill validator 216, and a card reader 212. These peripheral devices are well known devices in the field of vending machines generally and MDB compliant vending machines in particular. As implemented in FIG. 3, coin mechanism 214 and bill validator 216 connect directly to MDB 211 while card reader 212 is shown as connecting to MDB 211 using extended function adapter (EFA) 200 as an intermediary. In the depicted embodiment, card reader 212 connects to EFA 200 via a Universal Serial Bus (USB) connection 305. Card reader 212 is shown as including a magnetic strip reader 310, a Liquid Crystal Display (LCD) display 320, and a USB Interface 308, providing access to USB connection 308.

MDB 211 is compliant with the Multi-Drop Bus/Internal Communication Protocol (the MDB protocol) maintained by the National Automatic Marketing Association (NAMA). The MDB protocol is an Interface Standard that allows the various components of a vending machine to communicate to the VMC. The MDB protocol determines the way in which the VMC learns what coins were accepted by the Coin Mechanism, what bills were accepted by the Bill Validator, and how much credit is available through the Card Reader. It is a way for the VMC to “tell” the Coin Mechanism how much change to pay out or to “tell” the card reader how much credit to return to the card.

Unlike many shared bus protocols, the MDB protocol defines the VMC as the one and only master of the MDB and all other peripherals as slaves. The VMC can address packets to any of the peripheral devices, but peripheral devices cannot communicate with each other and only transmit packets to the VMC in response to receiving a packet from the VMC. Also, as suggested previously, MDB is a polling-based protocol. A significant percentage of MDB traffic consists of polling packets issued by the VMC and acknowledge packets from the peripheral devices. In most shared bus architectures, e.g., Ethernet and PCI, devices can act as masters or slaves and polling is not an inherent feature of the architecture.

EFA 200, as its name suggests, includes application extensions that enhance the features of field asset 200. In conjunction with VMC 210, EFA 200 may include an Audit Agent 302 suitable for retrieving DEX data 220 from VMC 210.

The elements of EFA 200 depicted in FIG. 3 include an audit agent 302. Audit agent 302 interacts with VMC 210, typically through a conventional RS-232 link, to retrieve or poll DEX data 220 from VMC 210. EFA 200 may be programmed to poll DEX data 220 multiple times each day and to store the data for each such polling event and the time associated with each event. In this manner, Audit agent 302 can create a dynamic view of DEX data.

Field asset 102 as depicted in FIG. 3, includes a serial bus or serial interface 330. Serial bus 330 may be, as an example, an RS-232 bus. Serial bus 330 as implemented in FIG. 3, connects EFA 200 and audit agent 302 to a externally accessible serial port 332. FIG. 3 further depicts a wireless adapter 10 as being connectable to serial port 332. The double sided arrow connecting wireless adapter 10 and serial port 332 emphasizes the ability of wireless adapter 10 to connect to and be disconnected from field asset 102.

Some embodiments of a data transfer method may be embodied in a set of computer executable instructions (software) for transferring data. The instructions are stored on one or more computer readable media such as a hard disk, a CD, a DVD, a floppy diskette, or in a memory devices such as a DRAM, SRAM, ROM, and/or flash memory device.

FIG. 4 depicts selected elements of a data transfer technique 400 according to one embodiment. In the installing (block 402) a standard jack of wireless adapter 10 in a communication port such as serial port 332 of field asset 102. Through the serial bus 320 and the EFA 200, wireless adapter is connected to a controller of field asset 102 such as VMC 210. Method 400 as depicted further includes communicating (block 404) data between a field asset controller such as VMC 210 and wireless adapter 10 over serial bus 330 and communication port 332. The data to be transferred is then wireless communicated (block 406) from wireless adapter 10 to hand held device 130. The data stored in hand held 130 is then communicated (block 408) from hand held device 130 to transaction server 110. The data may include DEX data that is stored in and/or maintained by VMC 210.

A wide variety of products and services are available to assist with wireless communication of information and data. Many of these products and services use BLUETOOTH® wireless technology to integrate electronic devices including, but not limited to, computers, laptop computers, mobile phones, personal data assistants (PDA), printers and barcode scanners into comprehensive enterprise wide communication networks.

RS232 is a common interface standard for data communication equipment that was developed by the Electronic Industries Association in the early 1960s. The name of the standard has been changed to “EIA232”. The standard may also be referred to as “EIA RS232” and “TIA 232.” A wide variety of RS232 serial ports, RS232 serial adapters and associated cables have been developed to provide wired connections between computers and peripheral equipment for transfer or communication of data therebetween.

Wireless RS232 serial communication products are available from several companies such as INTIUM. Such products often include a local area network communication device which may be hardwired into a circuit board or plugged into a circuit board using conventional multiprong connectors. Such wireless RS232 serial communication products typically allow wireless communication between computers and peripheral components without the use of standard RS232 cables or other types of hardwired networks.

For embodiments such as shown in FIG. 1, wireless adapter 10 may include housing 60 with universal probe or jack 30 extending from one end of housing 60. An RS232 wireless interface and associated components (not expressly shown) may be installed within housing 60 and connected with universal jack or plug 30. The RS232 wireless serial interface may include a low power short range wireless transceiver operable to use BLUETOOTH wireless technology or other suitable wireless protocols. A battery or other suitable power source may also be included within housing 60.

For some applications a tip ring sleeve (TRS) connector may be satisfactorily used as universal probe or jack 30. The connector may also be referred to as a “three-conductor plug” or as a “stereo jack plug.” However, such connectors and plugs are not limited to use in only stereophonic or other audio applications. Such connectors were frequently used with manual telephone exchanges.

Many facilities such as grocery stores, vending machines and loading docks have communication ports or access points adaptable for use with universal probes such as tip ring sleeve type jacks and plugs. Sockets associated with TRS connectors and manual telephone exchanges are often used to provide such communication ports.

Wireless adapter 10 eliminates the need for standard RS232 cables which are often used to connect handheld computers and other portable devices with outlets or serial ports.

For some applications universal probe or jack 30 may be generally described as a ¼″ three-conductor commercial phone plug such as a SwitchCraft Part No. 597 available from SwitchCraft, Inc. located in Chicago, Ill. RS232 wireless serial interfaces may be available from various companies such as INTIUM Co., Ltd. which sells several wireless products including INTIUM Promi SD101 BLUETOOTH RS232 Adapter.

A TRS socket (not expressly shown) may be connected to a computer network associated with a vending machine or a computer network associated with a store delivery system to provide an RS232 communication port. Appropriate contacts of the TRS socket or RS232 communication port may be physically connected with the ring, tip and sleeve (or a base) of universal probe or jack 30.

An operator may insert jack 30 of wireless adapter 10 into a communication port (e.g., port 332) or socket at a facility such as a vending machine or other field asset 102 or a store receiving delivery of products. A handheld wireless device such as a handheld computer 130 may contain software operable to discover and display a BLUETOOTH network name for each wireless adapter within range of the handheld wireless device. An operator may then select the desired wireless adapter by matching the BLUETOOTH network name with a label on the handheld wireless device. The user will then be able to perform serial communication exchange of data between the handheld wireless device and a computer network associated with the communication. For some applications wireless adapter 10 will preferably include a battery with sufficient life for a 10-hour shift.

As such, wireless adapter 10 is a portable device having a housing 60 and a first end (30) operable to connect to field asset (102) and, more specifically, connect to a source of transaction data such as the field asset controller 210 which includes a data structure identified as DEX data 220. Wireless adapter 10 also includes local wireless transmission functionality and sufficient storage and processing functionality to act as a data intermediary between field asset 102 and hand held 130. As depicted in FIG. 6, wireless adapter includes a processor connected to a wireless transceiver and a universal jack. The universal jack is operable to connect to a communication port of a field asset and receive data, preferably in a serial format such as RS 232 format. The processor is operable to transfer and reformat, to the extent necessary, the serial data received via the universal jack to the wireless transceiver, which may be a Bluetooth or other suitable wireless transceiver.

Typical uses of a wireless adapter incorporating teachings of the present disclosure and an associated wireless handheld electric device may include performing an average of five (5) DEX/UCS data exchanges per hour. Each DEX/UCS data exchange may include an associated BLUETOOTH discovery and connect followed by approximately ninety seconds are RS232 serial activity and followed by a BLUETOOTH disconnect procedure. Over the course of a typical 10-hour shift a user may perform over one and one-half hours of data exchange using a combination of DEX/UCS protocol, RS232 serial activity and associated BLUETOOTH communication technology.

Although the present disclosure and its advantages have been described in detail, it should be understood that various changes, substitutions and alternations can be made herein without departing from the spirit and scope of the disclosure as defined by the following claims.

What is claimed is:

1. A wireless adapter comprising:
a housing having a wireless transceiver disposed therein and a universal jack extending from one end of the housing;
the universal jack operable to be releasably engaged with a communication port;
a processor operable to convert RS232 data to BLUETOOTH data;
the processor operably coupled with the universal jack and the wireless transceiver; and
the wireless transceiver operable to communicate data between the communication port and a wireless electronic device.

2. The wireless adapter of claim 1 wherein the universal jack comprises a three-conductor plug defined in part by a tip, a ring and a sleeve.

3. The wireless adapter of claim 1 further comprising a power source coupled with the processor and the wireless transceiver.

4. The wireless adapter of claim 1 wherein the wireless electronic device further comprises a handheld computer operable to exchange inventory data, delivery data and invoice data with a computer network operably coupled with the communication port.

5. The wireless adapter of claim 1 further comprising the wireless transceiver operable to communicate with the wireless electronic device over a distance of approximately fifty feet.

6. A method to communicate data from a computer network to one or more handheld electronic devices comprising:
combining a wireless serial interface with a standard jack to form an integrated wireless adapter;
installing the standard jack into a communication port operably coupled to a computer network associated with a facility at a specific location;
communicating data between the communication network to the communication port using RS232 standards associated with hardwired data communication;
communicating RS232 data to the wireless serial interface using the standard jack;
converting the RS232 data to a wireless standard using the wireless serial interface; and
communicating the converted data using wireless technology to an electronic device operable to receive data from the wireless serial interface.

7. The method of claim 6 wherein the facility further comprises a grocery store, a vending machine, a shipping and receiving dock, a storefront, a beverage dispensing machine, an ice machine or a manufacturing facility.

8. The method of claim 7 further comprising the serial wireless interface using BLUETOOTH wireless technology.

9. The method of claim 6 further comprising communicating data between a vending machine and a handheld computer using the wireless technology and a DEX/UCS protocol.

10. The method of claim 6 further comprising communicating data between the electronic device and a communication port coupled with a computer network at a store using the wireless technology and a DEX/UCS protocol wherein the data is associated with direct delivery of consumer goods to the store.

11. A wireless adapter comprising a jack operable to connect to a serial port of a field asset and operable to receive serial data from the field asset, a wireless transceiver operable to transmit data received via the jack to a hand held wireless device.

12. The adapter of claim 11, wherein the serial port comprises a DEX port of a vending machine.
